(19) United States
(12) Patent Application Publication
(10) Pub. No.: US 2010/0057250 A1
(43) Pub. Date: Mar. 4, 2010

(54) DOSAGE MANAGEMENT SYSTEM AND APPARATUS FOR SUPPORTING A MEDICINE-TAKING SERVICE AND METHOD FOR SUPPORTING A MEDICINE-TAKING SERVICE USING THE SAME

(76) Inventors: Myung Eun Lim, Daejeon (KR); Jae Hun Choi, Daejeon (KR); Dae Hee Kim, Daejeon (KR); Sun Lee Bang, Daejeon (KR); Soo Jun Park, Seoul (KR); Seon Hee Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/410,508

(22) Filed: Mar. 25, 2009

(30) Foreign Application Priority Data
Aug. 27, 2008 (KR) 10-2008-0083945

(51) Int. Cl. G06F 17/00; G06Q 50/00

(52) U.S. Cl. 700/232; 705/2

(57) ABSTRACT

Provided are a dosage management system and an apparatus and method for supporting a medicine-taking service. The dosage management system includes a dosage management server managing information required for a dosage schedule and support of a medicine-taking service, and transmitting a corresponding dosage schedule on demand of the dosage schedule; and an apparatus for supporting a medicine-taking service, wherein the apparatus for supporting a medicine-taking service deposits packets of medicines packaged in a series of medicine packets, receives a corresponding dosage schedule, displays medicine-tacking alarm according the received corresponding dosage schedule, sequentially discharges one of the deposited packets of medicines, checks whether a user takes a packet of medicines to transmit the result of taking medicine to the dosage management server.

### CROSS-REFERENCE TO RELATED APPLICATIONS

This application claims the priority of Korean Patent Application No. 2008-83945 filed on Aug. 27, 2008, in the Korean Intellectual Property Office, the disclosure of which is incorporated herein by reference.

### BACKGROUND OF THE INVENTION

1. Field of the Invention

The present invention relates to a dosage management system, and more particularly, to an apparatus for supporting a medicine-taking service that allows a user to take a packet of medicaments that are packaged in a paper bag in the dosage management system, and a method for managing a medicine-taking service in the apparatus.

2. Description of the Related Art

Continuous dosage management for chronic diseases patients is one of the very important matters to manage diseases. However, it may be difficult for the aged to continuously take medicine in time without making a separate dosage management due to the failure of their memories. In order to solve the problems, there has been a demand for technologies to support a planned medicine-taking service.

Conventional technologies for dosage management have developed, comprising: informing medicine-taking time by medicine cases, that is, filling partitions of each medicine case with medicaments and informing medicine-taking time at a pre-set time, wherein the partitions of each medicine case are classified according to the date or time to take medicine.

However, as officinal medicines tend to be recently substituted with packets of medicines due to the unsanitary causes such as hygiene, there has been required a method for supporting a medicine-taking service which can be applied to the packet of medicines. In order to support a user to take the packets of medicines, only the technologies to simply deposit the packets of medicines have developed in the art. Therefore, new technologies for a packet of medicines are required to inform a user of a medicine-taking time and manage whether a user takes medicine or not, etc.

Meanwhile, a technology for determining that a user takes medicine when the user opens a medicine packet having a special electric resistance apparatus installed therein has developed in the art in order to check whether a user take a packet of medicines. However, this technology has problems in that a medicine packet having an electric apparatus installed therein costs a great deal of money to produce, and it is impossible to use conventional packets of medicines as they are.

### SUMMARY OF THE INVENTION

The present invention is designed to solve the problems of the prior art, and therefore it is an object of the present invention to provide a dosage management system that deposits medicaments packaged in a series of medicine packets, informs a medicine-taking time of each medicine packet, discharges a packet of medicines and informs a dosage management server that a user takes medicine.

Also, it is another object of the present invention to provide an apparatus and method for supporting a medicine-taking service using the dosage management system.

According to an aspect of the present invention, there is provided a dosage management system including a dosage management server managing information required for a dosage schedule and support of a medicine-taking service, and transmitting a corresponding dosage schedule on demand of the dosage schedule; and an apparatus for supporting a medicine-taking service, wherein the apparatus for supporting a medicine-taking service deposits packets of medicines packaged in a series of medicine packets, receives a corresponding dosage schedule, displays medicine-taking alarm according the received corresponding dosage schedule, sequentially discharges one of the deposited packets of medicines, checks whether a user takes a packet of medicines to transmit the result of taking medicine to the dosage management server.

According to another aspect of the present invention, there is provided an apparatus for supporting a medicine-taking service including a storage unit depositing packets of medicines packaged in a series of medicine packets; a processor unit controlling synchronization of a dosage schedule with the dosage management server for managing the dosage schedule, controlling discharge of one of the packets of medicines deposited in the storage unit by determining whether it is time to take medicine according to the dosage schedule received from the dosage management server, and checking whether a user takes a packet of medicines; a communication unit accessing the dosage management server to transmit information on the synchronization of the dosage schedule and whether to take a packet of medicines; a packet-of-medicines discharging port sequentially receiving the packets of medicines deposited in the storage unit and discharging one of the deposited packets of medicines when it is time to take medicine; and a display unit displaying the medicine-taking alarm.

According to still another aspect of the present invention, there is provided a method for supporting a medicine-taking service in the apparatus for supporting a medicine-taking service. In this case, the method includes: depositing packets of medicines packaged in a series of medicine packets; synchronizing a dosage schedule with a dosage management server which manages the dosage schedule; informing a user of a medicine-taking time according to the corresponding dosage schedule synchronized and received from the dosage management server when it is time to take medicine; discharging one of the deposited packets of medicines; and checking whether a user takes the discharged packet of medicines to transmit the result of taking medicine to the dosage management server.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a configuration of a dosage management system according to one exemplary embodiment of the present invention.

FIG. 2 is a diagram illustrating an exploded configuration of an apparatus for supporting a medicine-taking service according to one exemplary embodiment of the present invention.

FIG. 3 is a diagram illustrating an exploded configuration of a packet-of-medicines discharging port of the apparatus for supporting a medicine-taking service according to one exemplary embodiment of the present invention.

FIG. 4 is a diagram illustrating one example of a database in the dosage management server according to one exemplary embodiment of the present invention.

FIG. 5 is a diagram illustrating an exploded configuration of the dosage management server according to one exemplary embodiment of the present invention.

FIG. 6 is a flowchart illustrating a method for supporting a medicine-taking service in the apparatus for supporting a medicine-taking service according to one exemplary embodiment of the present invention.

FIG. 7 is a flowchart illustrating an operation of synchronizing a dosage schedule according to one exemplary embodiment of the present invention.

### DETAILED DESCRIPTION OF THE PREFERRED EMBODIMENT

Hereinafter, exemplary embodiments of the present invention will now be described in detail with reference to the accompanying drawings. For the exemplary embodiments of the present invention, detailed descriptions of known functions and constructions that are related to the present invention are omitted for clarity when they are proven to make the gist of the present invention unnecessarily confusing.

In accordance with one exemplary embodiment of the present invention, the apparatus and method for supporting a medicine-taking service that support a user to take a packet of medicines packaged in a series of medicine packets will be described in more detail, as follows. First of all, a configuration of the apparatus for supporting a medicine-taking service is described in more detail with reference to the accompanying drawings.

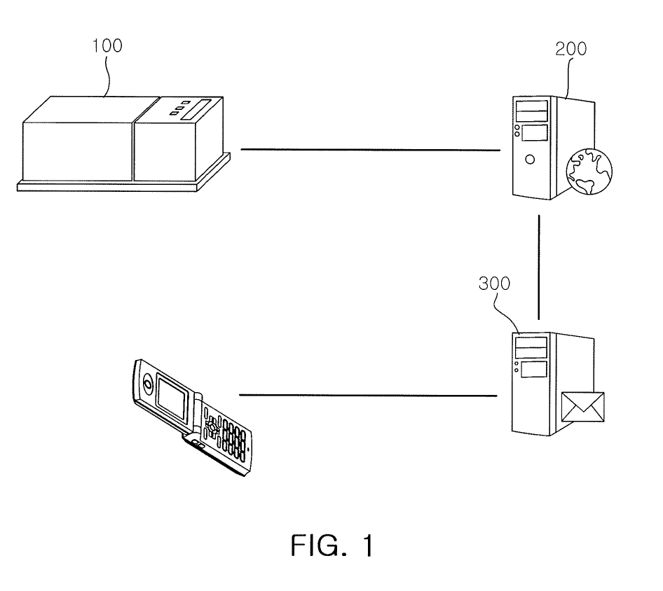

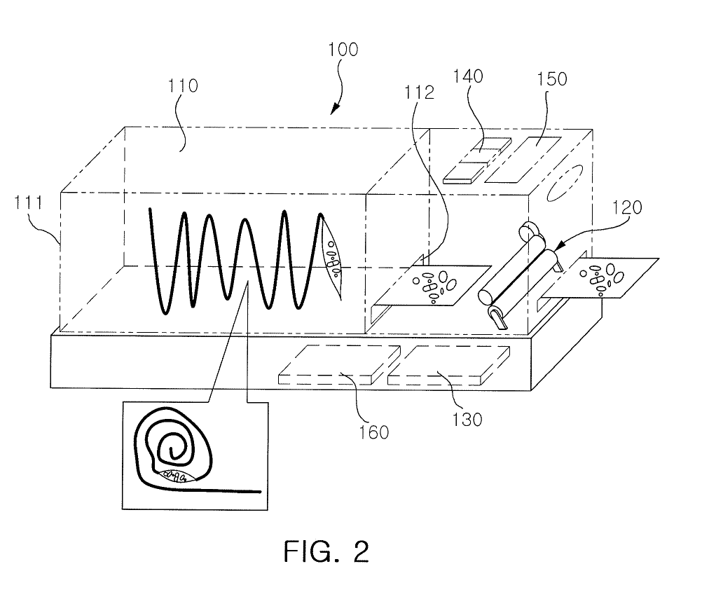

FIG. 1 is a diagram illustrating a configuration of a dosage management system according to one exemplary embodiment of the present invention, and FIG. 2 is a diagram illustrating an exploded configuration of an apparatus for supporting a medicine-taking service according to one exemplary embodiment of the present invention.

Referring to FIG. 1, the dosage management system includes an apparatus 100 for supporting a medicine-taking service in the form of a medicine case; and a dosage management server 200. Here, the dosage management system may include a message server 300 coupled to a user's mobile phone. In this case, the message server 300 may use servers of preexisting communication companies or short message service (SMS) hosting partners.

Referring to FIG. 2, the apparatus 100 for supporting a medicine-taking service deposits a packet of medicines, informs a medicine-taking time and discharges medicaments, and may be composed of a body including a storage unit 110, a packet-of-medicines discharging port 120, a processor unit 130, an input unit 140, a display unit 150 and a communication unit 160.

The storage unit 110 deposits packets of medicines packaged in a series of medicine packets so that the medicine packets can be discharged sequentially. Here, the storage unit 110 includes a lid 111 formed therein to store the packets of medicines in a scrolled state (A) or a folded state (B), and a deposit outlet 112 formed therein and coupled to a body to transmit packets of medicines to the packet-of-medicines discharging port 120. The packets of medicines deposited in the storage unit 110 are connected in series without severing of the packets of medicines.

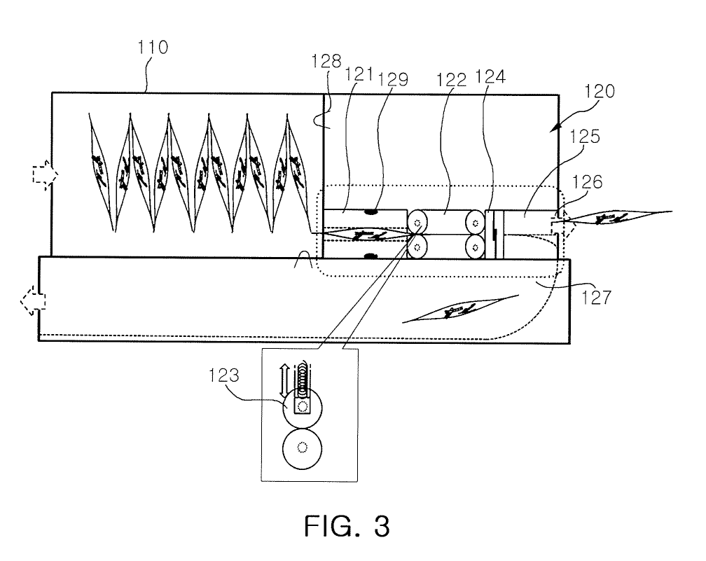

The packet-of-medicines discharging port 120 receives the packets of medicines from the storage unit 110, and automatically discharges the packets of medicines one by one at a given time. And the packet-of-medicines discharging port 120 may be composed of a medicine-waiting portion 121, an automatic conveyor 122, a rotatable support 123, a cutting machine 124, a discharge/separation unit 125, an outlet 126 and an untaken medicine room 127, as shown in FIG. 3. Also, the packet-of-medicines discharging port 120 may further include a switch sensor 128 detecting whether the storage unit 110 is installed in the body. The medicine-waiting portion 121 includes a sensor 129 detecting whether there are stacked packets of medicines. The automatic conveyor 122 is composed of a roller or belt, and a motor that can rotate the roller or belt in a predetermined direction, and functions to automatically convey the medicine packets as the packets of medicines are inserted into the medicine-waiting portion 121. The rotatable support 123 is composed of springs so as to support a roller or belt, which allows the roller or belt to elastically moves up and down when a thick packet of medicines hangs on the roller or belt. The cutting machine 124 cuts one of the medicine packets outputted from the automatic conveyor 122, and the discharge/separation unit 125 separates the cut medicine packet into the outlet 126 or the untaken medicine room 127. This medicine-discharging operation of the packet-of-medicines discharging port 120 is described in more detail with reference to the FIG. 3.

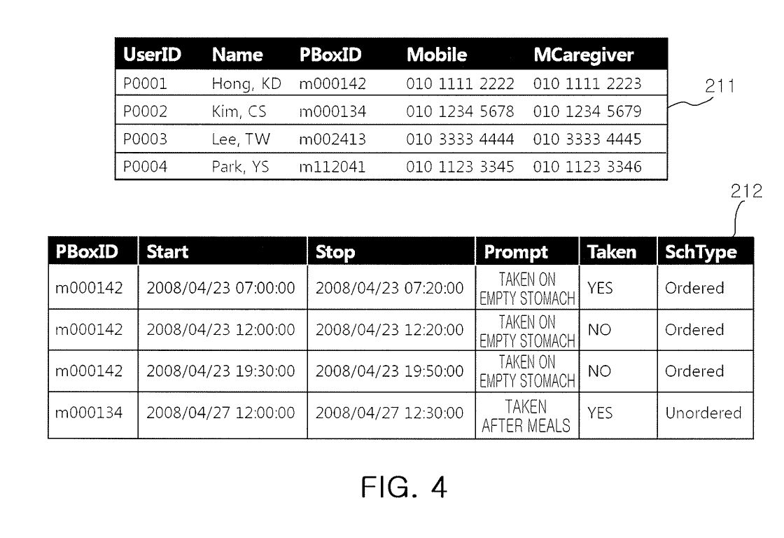

The processor unit 130 includes a main processor (not shown) calculating a medicine-taking alarm time according to the information inputted through the display unit 150, controlling the discharge of the packets of medicines and determining whether to transmit a message informing that a user takes medicine according to the conditions; and a non-volatile memory (not shown) storing a dosage schedule, information about whether a user takes medicine and whether the dosage management server synchronizes with the information about whether a user takes medicine, etc. More particularly, the processor unit 130 serves together with the dosage management server 200 to control the synchronization with the dosage schedule, determine whether there are medicines and control the sensor 129 in the medicine-waiting portion 121 so as to determine whether there are medicines, determine whether it is a medicine-taking time according to the time maintenance and dosage schedule, control an alarm display unit to inform that it is a medicine-taking time, determine whether a user takes medicine, control the discharge of medicaments, and control a going-out status by selecting a going-out mode of the input unit 140. Here, the dosage schedule and the determination whether a user takes medicine, stored in the non-volatile memory, are represented, based on the information as shown in FIG. 4. Here, the information on ‘the synchronization of dosage management server with the determination whether a user takes medicine’ and ‘the going-out mode’ is further added as fields having values of ‘Yes’ and ‘No,’ respectively. Basically, the processor unit 130 stores data such as IP address of the dosage management server 200 for communicating with the dosage management server 200.

The input unit 140 is composed of handling buttons to select modes for supporting a user to take medicine, that is, a mode for canceling synchronization with a dosage schedule, a mode for canceling a dosage schedule, a mode for discharging medicaments, a going-out mode, etc. In addition, the input unit 140 may be composed to search menus for selecting a conditional status of a medicine case and set the dosage management server 200 and handle setting buttons, etc.

The display unit 150 is composed of LCD or LED and a speaker to visually and auditorily inform a user that it is a medicine-taking time. When it is a medicine-taking time, the display unit 150 informs a user that it is a medicine-taking time by turning on and off a colored LED, and uses a textual LCD to output a text message including a medicine-taking time, medicine-taking procedures, medicinal components, etc.

The communication unit 160 may be composed of wireless/cable LAN that may come in direct contact with internet, a wireless communication apparatus that may communicate with a modem or an in-house set-top box for health cares through a Zigbee protocol and the like. The communication unit 160 functions to receive a dosage schedule from the dosage management server 200 and transmit medicine-taking results (the synchronization of information on medicines, the information on whether a user takes medicine, etc) according to the dosage schedule to the dosage management server 200.

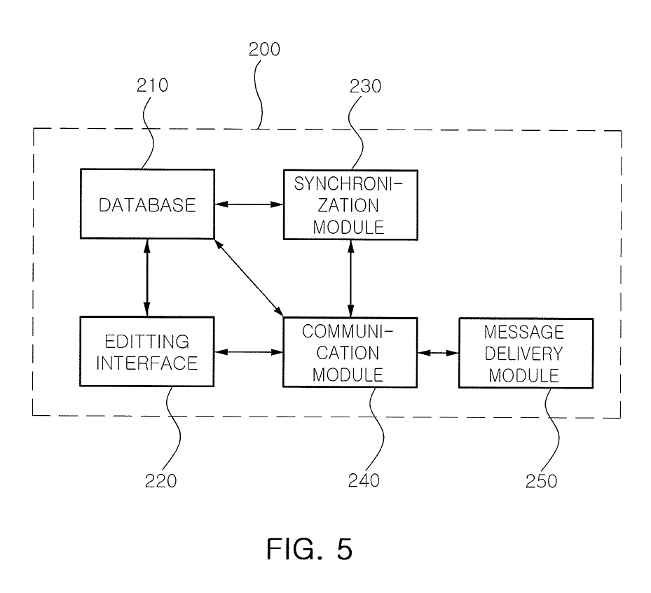

Meanwhile, the dosage management server 200 functions to store and edit a dosage schedule and information on whether a user takes medicine. In this case, dosage management server 200 may include a database 210 storing information on dosage managements, an editing interface 220 editing the context of the corresponding database 210, a synchronization module 230 transmitting a dosage schedule to the apparatus 100 for supporting a medicine-taking service and receiving information on whether a user takes medicine, a communication module 240 transmitting a dosage schedule on demand of the apparatus 100 for supporting a medicine-taking service and receiving information on whether a user takes medicine from the corresponding apparatus 100 for supporting a medicine-taking service, and a message delivery module 250 transmitting the received information through a short message service, as shown in FIG. 5. Here, the communication module 240 has its own messaging protocol. The information on dosage managements stored in the database 210 includes a dosage schedule of a patient who becomes the object of dosage managements, and information on whether the patient takes medicine according to the corresponding dosage schedule, information on the apparatus 100 for supporting a medicine-taking service and a user, etc. For example, this information is shown in FIG. 4.

As shown in FIG. 4, the data stored in the database 210 are composed of a user information table 211 and a schedule table 212. Here, the user information table 211 is composed of fields each including user's ID, user's name, ID of the apparatus for supporting a medicine-taking service, patient's mobile phone number and caregiver's mobile phone number. The schedule table 212 is composed of fields each including ID of the apparatus for supporting a medicine-taking service, alarm start time, alarm stop time, medicine-taking procedures and cautions, information on whether a user takes medicine, a dosage schedule type. Therefore, when the dosage management server 200 receives a request for a dosage schedule from the apparatus 100 for supporting a medicine-taking service, the dosage management server 200 transmits the dosage schedule to the apparatus 100 for supporting a medicine-taking service in the form of lists including ‘ID of a medicine case, alarm start time, alarm stop time, medicine-taking procedures and cautions, and schedule type.’ Here, the lists in the dosage schedule are arranged and transmitted according to the alarm time order.

In the above-mentioned apparatus 100 for supporting a medicine-taking service, an operation of discharging medicaments from the packet-of-medicines discharging port 120 is described in more detail with reference to FIG. 3.

Referring to FIG. 3, when the storage unit 110 is installed in the body, packets of medicines, which are packaged in a series of medicine packets and deposited in the storage unit 110, are sequentially inserted into the medicine-waiting portion 121. That is to say, the storage unit 110 inserts the packets of medicines into a reference point by pushing a front portion of the packets of medicines along a path of the medicine-waiting portion 121. Then, the automatic conveyor 122 conveys the packets of medicines standing by in the medicine-waiting portion 121 to a cutting point, and temporarily fixes the packets of medicines in the cutting point. Therefore, the cutting machine 124 automatically cut the fixed packets of medicines at the cutting point. In this case, the discharge/separation unit 125 allows the packet of medicines to move up and down in a predetermined direction, thus to determine which direction to discharge the cut packet of medicines from the packet-of-medicines discharging port 120 and convey the packet of medicines. That is to say, the discharge/separation unit 125 discharges a packet of medicines through the outlet 126 when a user presses a medicine-discharging button to take medicine and the discharge/separation unit 125 then receives a medicine-discharging signal from the input unit 140. On the contrary, when a user does not take the cut packet of medicines within an effective time or selects a mode for canceling a dosage schedule from a menu, the cut packet of medicines is conveyed and stored in the untaken medicine room 127. Here, the expression ‘effective time’ may be differently defined according to the alarm conditions, for example, after a lapse of some time period from an appointed medicine-taking time or right before the next medicine-taking time. When the packet of medicines that a user does not take is stored in the untaken medicine room 127 as described above, it is possible to prevent a user from taking wrong medicaments that are discharged according to the next dosage schedule when the user does not take medicine on time. And a lid is formed in the untaken medicine room 127 to collect and process the medicaments in the untaken medicine room 127 at a time.

Then, the method for supporting a medicine-taking service in the apparatus for supporting a medicine-taking service are described in more detail in the dosage management system as configured thus, with reference to the accompanying drawings.

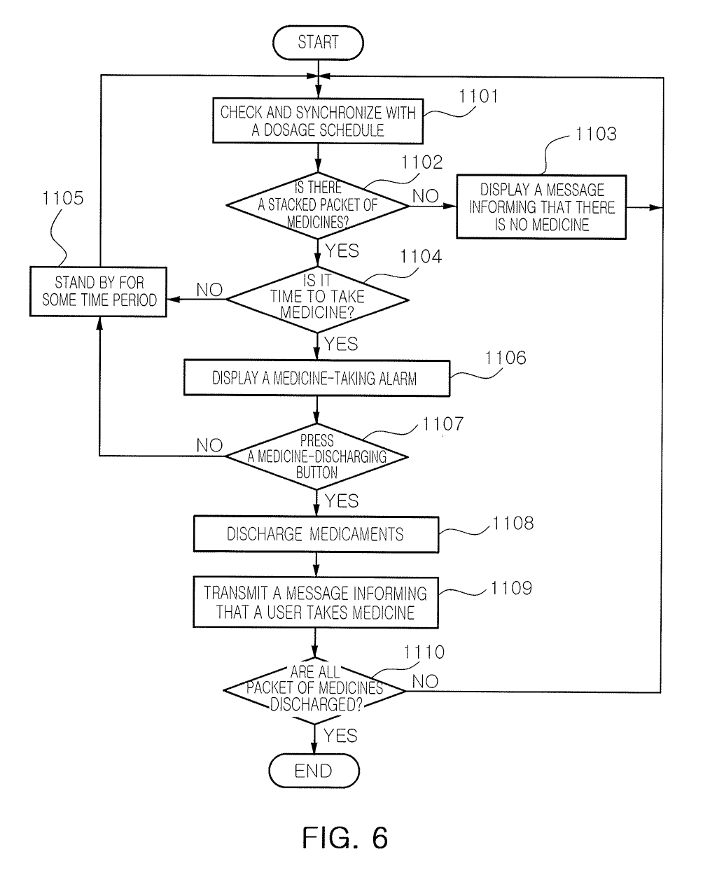

FIG. 6 is a flowchart illustrating a method for supporting a medicine-taking service in the apparatus for supporting a medicine-taking service according to one exemplary embodiment of the present invention.

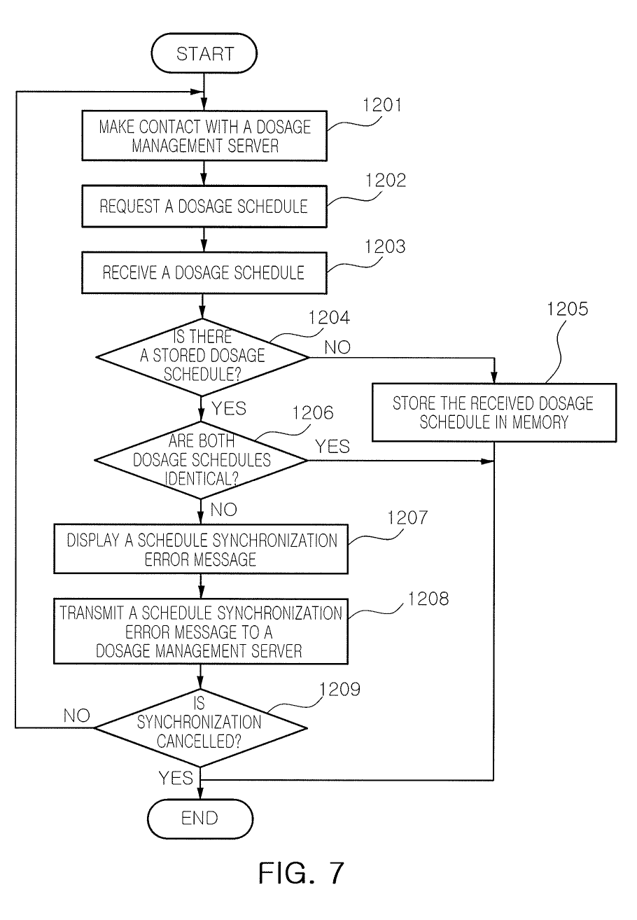

Referring to FIG. 6, when the apparatus 100 for supporting a medicine-taking service is turned on, or the storage unit 110 is installed into the body, the apparatus 100 for supporting a medicine-taking service checks an existing dosage schedule, and then synchronizes the dosage schedule with the dosage management server 200 (Operation 1101). This operation 1101 is described in more detail with reference to FIG. 7.

Referring to FIG. 6, after the synchronization of the dosage schedule with the dosage management server 200 is completed, the apparatus 100 for supporting a medicine-taking service checks whether there are stacked packets of medicines in the medicine-waiting portion 121 when the existing dosage schedule is not in discord with a new dosage schedule (Operation 1102) As a result, when there is no medicament in the medicine-waiting portion 121, the apparatus 100 for supporting a medicine-taking service transmits a message informing that there is no medicament to the display unit 150 and then allow the display unit 150 to display the message informing that there is no medicament, or to generate an alarm signal (Operation 1103). On the contrary, when there are the stacked packets of medicines in the medicine-waiting portion 121, the apparatus 100 for supporting a medicine-taking service checks whether it is time to take medicine according to the most precedent dosage schedule (Operation 1104). When it is not the time to take medicine, the apparatus 100 for supporting a medicine-taking service allows the packets of medicines to stand by for some time period (Operation 1105), followed by returning to operation 1101. Here, there are two alarm methods of informing that it is a medicine-taking time, depending on the dosage schedule. In this case, the dosage schedule is composed of an alarm start time and an alarm stop time. Therefore, the two alarm methods are divided into an ‘On time’ alarm informing that it is a medicine-taking time spanning from the alarm start time to the alarm stop time, and an ‘Over time’ alarm informing that the medicine-taking time is over, which spans from the alarm stop time to a limit time as pre-set to the medicine case.

On the contrary, when it is time to take medicine, the apparatus 100 for supporting a medicine-taking service transmits a medicine-taking alarm message to the display unit 150 so as to display that it is a medicine-taking time or generates an alarm signal (Operation 1106). Here, the medicine-taking alarm message occasionally transmits the medicine-taking alarm message according to two kinds of the dosage schedules. For this purpose, the processor unit 130 outputs the medicine-taking alarm message at two steps according to the conditions by comparing the current time with the time of the dosage schedule. Therefore, when a user checks the display unit 150 to take medicine, the user presses a medicine-discharging button of the input unit 140.

The processor unit 130 of the apparatus 100 for supporting a medicine-taking service checks whether a medicine-discharging signal is received from the input unit 140 as the user pressed the medicine-discharging button (Operation 1107). As a result, when the medicine-discharging signal is received from the input unit 140, the apparatus 100 for supporting a medicine-taking service conveys the packets of medicines standing by in the medicine-waiting portion 121 using the automatic conveyor 122, cuts one of the conveyed packets of medicines using the cutting machine 124, and discharges the cut packet of medicines through the outlet 126 (Operation 1108). Here, when the apparatus 100 for supporting a medicine-taking service determines that the user takes medicine after the user presses the medicine-discharging button to discharge the medicaments, the apparatus 100 for supporting a medicine-taking service records in the non-volatile memory the context that the apparatus 100 discharges the packet of medicines through the outlet 126 and the user then takes medicine according to the dosage schedule of the corresponding packet of medicines.

On the contrary, when the medicine-discharging signal is not received from the input unit 140, the user does not take medicine. Therefore, the apparatus 100 for supporting a medicine-taking service stands by for some time period (effective time) (Operation 1105), followed by performing operation 1101. In this case, the discharge/separation unit 125 of the packet-of-medicines discharging port 120 transmits the packet of medicines to the untaken medicine room 127. When the medicine-taking is not completed since the user does not take medicine, the apparatus 100 for supporting a medicine-taking service records in the non-volatile memory the context that the user does not take the corresponding packet of medicines.

Meanwhile, when the medicine-taking time is over, which spans from the alarm stop time to a limit time as pre-set to the medicine case, or when the next medicine-taking time is ripe, the apparatus 100 for supporting a medicine-taking service discharges medicaments without displaying a medicine-taking alarm, regardless of whether a user presses the medicine-discharging button. In the case of this medicine-discharging operation, the medicine-discharging order may be varied according to the type of the dosage schedule. In general, filled medicaments are divided into two groups: one is an order-variable medicine that may be taken regardless of the medicine-taking order since the filled medicaments have the same components; and the other is an order-fixed medicine that should be necessarily taken according to the medicine-taking order since components of the medicine are differently filled according to the medicine-taking times such as morning, noon and evening. Even when a user omits the dosage schedule without taking the order-variable medicine, the user may taking the order-variable medicine according to the next dosage schedule without any problems. Therefore, it is possible not to discharge medicaments into the untaken medicine room 127 even when the dosage schedule is over. However, when a user omits the dosage schedule without taking the order-fixed medicine (for example, when it is time that a user takes medicine in the evening without taking medicine at noon), the corresponding medicaments of the lapsed dosage schedule should be discharged into the untaken medicine room 127.

Then, the apparatus 100 for supporting a medicine-taking service accesses the dosage management server 200 to transmit to the dosage management server 200 a message informing medicine-taking information including whether a user takes medicine (Operation 1109). In this case, when, among the previous dosage schedules, there is a dosage schedule whose medicine-taking information informing whether a user takes medicine is not transmitted to the dosage management server 200, the apparatus 100 for supporting a medicine-taking service also transmits the medicine-taking information of the corresponding dosage schedule to the dosage management server 200. When the apparatus 100 for supporting a medicine-taking service fails to access the dosage management server 200, the apparatus 100 for supporting a medicine-taking service records a server synchronization records of the corresponding dosage schedule as uncompleted status on the non-volatile memory, thereby synchronizing the uncompleted synchronization of dosage schedule when the apparatus 100 for supporting a medicine-taking service accesses the dosage management server 200 next time.

Then, the apparatus 100 for supporting a medicine-taking service checks whether all the packets of medicines are discharged (Operation 1110). As a result, when all the packets of medicines are not discharged, the apparatus 100 for supporting a medicine-taking service returns to operation 1101, followed by repeating the subsequent operations. When all the packets of medicines are discharged, the medicine-discharging operation is completed. Meanwhile, the remaining medicaments after the dosage schedule is completed are collectively discharged into the untaken medicine room 127 without automatically cutting the packets of medicaments.

When the packets of medicines are not discharged while being hanged on or held behind the apparatus, the apparatus 100 for supporting a medicine-taking service also informs a user by displaying these conditions through the display unit 150. Then, the user may remove the storage unit 110 from the body to re-stack the packets of medicines.

In the method for supporting a medicine-taking service, the operation of synchronizing the dosage schedule is described in more detail with reference to FIG. 7.

Referring to FIG. 7, the apparatus 100 for supporting a medicine-taking service first accesses the dosage management server 200, and receives information on time to synchronize the dosage schedule with time (Operation 1201), and the processor unit 130 requests a dosage schedule of a patient to the dosage management server 200 (Operation 1202). Accordingly, the dosage management server 200 transmits the requested dosage schedule stored in the database 210 to the apparatus 100 for supporting a medicine-taking service. Then, the apparatus 100 for supporting a medicine-taking service receives a dosage schedule from the dosage management server 200 (Operation 1203).

Then, the apparatus 100 for supporting a medicine-taking service checks whether there is a dosage schedule stored in the non-volatile memory (Operation 1204). When there is no dosage schedule, the apparatus 100 for supporting a medicine-taking service stores the received dosage schedule in the non-volatile memory (Operation 1205), and the operation is then completed. On the contrary, when there is a dosage schedule stored in the non-volatile memory, the apparatus 100 for supporting a medicine-taking service checks whether the received dosage schedule is identical to the previously stored dosage schedule by comparing the received dosage schedule with the previously stored dosage schedule (Operation 1206), and the operation is then completed when the received dosage schedule is identical to the previously stored dosage schedule. On the contrary, when the received dosage schedule is not identical to the previously stored dosage schedule, the apparatus 100 for supporting a medicine-taking service transmits a schedule synchronization error message to the display unit 150 to inform a user that there are schedule synchronization errors (Operation 1207), and also transmits a schedule synchronization error message to the dosage management server 200 (Operation 1208). Accordingly, the dosage management server 200 receives the schedule synchronization error message to inform a schedule manager that there are schedule synchronization errors, thereby inducing the adjustment of the dosage schedule.

Finally, the apparatus 100 for supporting a medicine-taking service checks whether the synchronization of the dosage schedule is cancelled (Operation 1209). When the synchronization of the dosage schedule is cancelled by a user, the operation is completed. On the contrary, when the synchronization of the dosage schedule is not cancelled by the user, the apparatus 100 for supporting a medicine-taking service returns to operation 1201 and periodically repeats the subsequent operations until the dosage schedule is edited in the dosage management server 200 or updated by a user, or until the synchronization of the dosage schedule is explicitly cancelled by the user.

Also, since the apparatus 100 for supporting a medicine-taking service basically stores a dosage schedule in a non-volatile memory (not shown), the dosage schedule is stored in the non-volatile memory even when the apparatus 100 for supporting a medicine-taking service is turned off. Therefore, when the apparatus 100 for supporting a medicine-taking service is turned on, it may support a medicine-taking service according to the previously stored dosage schedule although the dosage schedule is not synchronized due to the errors in connection with the server.

Unlike the above-mentioned exemplary embodiments, a user may continue to be served a medicine-taking alarm service even when the user is not at home but goes out. Therefore, when the user selects a going-out mode on LDC of the display unit 150 and select the number of medicaments that the user will carry when he goes out, the apparatus 100 for supporting a medicine-taking service discharges as many packets of medicines as selected by the user, and then converts all the dosage schedules of the corresponding medicaments into a going-out mode. When it is a medicine-taking time according to the corresponding dosage schedule converted into a going-out mode, the apparatus 100 for supporting a medicine-taking service transmits a medicine-taking alarm message according to the corresponding dosage schedules, by using the message delivery module 250 of the dosage management server 200, regardless of the presence of the medicaments in the medicine-waiting portion 121. Then, when the user takes the corresponding medicaments, the dosage management server 200 receives from the user a message informing that the user takes medicine in response to the medicine-taking alarm message, and updates the dosage schedule.

As described above, the dosage management system according to the present invention includes the apparatus for supporting a medicine-taking service capable of discharging a packet of medicines according to the dosage schedule. Therefore, a doctor, a caregiver and a patient's family can continuously and easily manage patient's conditions, depending on the prescription for the patient, since the dosage management system may be used for the purpose of systemic dosage management in homes, hospitals or nursing facilities.

While the present invention has been shown and described in connection with the exemplary embodiments, it will be apparent to those skilled in the art that modifications and variations can be made without departing from the spirit and scope of the invention as defined by the appended claims. Therefore, it should be understood that the scope of the present invention is not designed to limit the exemplary embodiments of the present invention, but is construed as being the appended claims and equivalents thereof.

What is claimed is:

1. A dosage management system, comprising:
a dosage management server managing information required for a dosage schedule and support of a medicine-taking service, and transmitting a corresponding dosage schedule on demand of the dosage schedule; and
an apparatus for supporting a medicine-taking service,
wherein the apparatus for supporting a medicine-taking service deposits packets of medicines packaged in a series of medicine packets, receives a corresponding dosage schedule, displays medicine-taking alarm according the received corresponding dosage schedule, sequentially discharges one of the deposited packets of medicines, checks whether a user takes a packet of medicines to transmit the result of taking medicine to the dosage management server.

2. The dosage management system of claim 1, wherein the dosage management server comprises:
a database storing information required for the dosage schedule and the support of a medicine-taking service;
a synchronization module synchronizing the dosage schedule with the apparatus for supporting a medicine-taking service;
an editing interface editing the dosage schedule; and
a communication module transmitting the corresponding dosage schedule to the apparatus for supporting a medicine-taking service and receiving whether to take medicine from the apparatus for supporting a medicine-taking service.

3. The dosage management system of claim 2, wherein the dosage management server further comprises a message delivery module transmitting to a user's mobile phone a message about whether to take a packet of medicines.

4. The dosage management system of claim 1, wherein, when a user selects a going-out mode to discharge medicaments from the apparatus for supporting a medicine-taking service and carries the medicaments, the dosage management server receives a request from the apparatus for supporting a medicine-taking service to transmit a medicine-taking alarm message to a user's mobile phone when it is time to take medicine, and receive a response message from the user to update a dosage schedule according to the going-out mode.

5. An apparatus for supporting a medicine-taking service, comprising:
a storage unit depositing packets of medicines packaged in a series of medicine packets;
a processor unit controlling synchronization of a dosage schedule with the dosage management server for managing the dosage schedule, controlling discharge of one of the packets of medicines deposited in the storage unit by determining whether it is time to take medicine according to the dosage schedule received from the dosage management server, and checking whether a user takes a packet of medicines;
a communication unit accessing the dosage management server to transmit information on the synchronization of the dosage schedule and whether to take a packet of medicines;
a packet-of-medicines discharging port sequentially receiving the packets of medicines deposited in the storage unit and discharging one of the deposited packets of medicines when it is time to take medicine; and
a display unit displaying the medicine-taking time.

6. The apparatus of claim 5, further comprising an input unit selecting discharge of medicine, cancellation of dosage schedule, or a going-out mode by a user to transmit a corresponding signal to the processor unit.

7. The apparatus of claim 5, wherein the packet-of-medicines discharging port comprises:
a medicine-waiting portion sequentially receiving packets of medicines deposited in the storage unit to allow the received packets of medicines to stand by;
an automatic conveyor automatically conveying the packets of medicines standing by in the medicine-waiting portion and temporarily fixing the packets of medicines in a region of a cutting-plane line;
a cutting machine cutting one of the fixed packets of medicines; and
an outlet discharging the cut packet of medicines.

8. The apparatus of claim 7, wherein the packet-of-medicines discharging port further comprises:
a discharge/separation unit determining which direction to discharge the cut packet of medicines according to the conditions pre-set by a user; and
an untaken medicine room storing the cut packet of medicines when a user does not take the packet of medicines at a pre-set time.

9. The apparatus of claim 5, wherein the processor unit checks whether there are the packets of medicines standing by in the medicine-waiting portion and transmits to the display unit a message informing that there is no medicine.

10. A method for supporting a medicine-taking service in the apparatus for supporting a medicine-taking service, the method comprising:
depositing packets of medicines packaged in a series of medicine packets;
synchronizing a dosage schedule with a dosage management server which manages the dosage schedule;
informing a user of a medicine-taking time according to the corresponding dosage schedule synchronized and received from the dosage management server when it is time to take medicine;
discharging one of the deposited packets of medicines; and
checking whether a user takes the discharged packet of medicines to transmit the result of taking medicine to the dosage management server.

11. The apparatus of claim 10, further comprising:
discharging as many deposited packets of medicines as a user carries when the user presses a going-out mode button; and
informing a user that the user should take medicine to a user's mobile phone when it is time to take medicine.

12. The apparatus of claim 10, wherein the operation of synchronizing a dosage schedule with a dosage management server comprise:
accessing the dosage management server to synchronize time;
receiving the corresponding dosage schedule from the dosage management server; and
storing the received corresponding dosage schedule.

13. The apparatus of claim 12, wherein the operation of synchronizing a dosage schedule with a dosage management server further comprise:
determining whether the previously stored dosage schedule is identical to the received corresponding dosage schedule by comparing the previously stored dosage schedule with the received corresponding dosage schedule when there is the previously stored dosage schedule;
displaying a schedule synchronization error message when the previously stored dosage schedule is different from the received corresponding dosage schedule; and
transmitting the schedule synchronization error message to the dosage management server.

14. The apparatus of claim 10, wherein the operation of discharging one of the deposited packets of medicines comprises:
allowing the deposited packets of medicines to sequentially stand by;
conveying the standing-by packets of medicines to cut a cutting-plane line of the standing-by packets of medicines when it is time to take medicine;
discharging the cut packet of medicines when a user presses a medicine-discharging button and the apparatus receives a signal for discharging medicaments; and
storing the cut packet of medicines in an untaken medicine room when the dosage schedule is over or the dosage schedule is cancelled.

15. The apparatus of claim 14, further comprising: conveying all the remaining medicaments to the untaken medicine room when all dosage schedules are completed and storing the remaining medicaments without automatically cutting medicine packets.
